(19) United States
(12) Patent Application Publication
(10) Pub. No.: US 2011/0095654 A1
(43) Pub. Date: Apr. 28, 2011

(54) APPARATUS FOR GENERATING ELECTRICAL ENERGY FROM MECHANICAL VIBRATIONS HAVING A WIDE VARIETY OF AMPLITUDES AND FREQUENCIES BY MEANS OF PIEZO SENSORS

(75) Inventors: Thorsten Steinkopff, Egmating (DE); Andreas Wolff, München (DE)

(73) Assignee: Siemens Aktiengesellschaft, Munich (DE)

(21) Appl. No.: 12/737,217

(22) PCT Filed: May 12, 2009
(86) PCT No.: PCT/EP2009/055724

§ 371 Date: Dec. 20, 2010

(51) Int. Cl. H02N 2/18

(52) U.S. Cl. 310/339

(57) ABSTRACT

An apparatus couples mechanical energy in the form of wide-range mechanical vibrations to a piezo sensor, especially a multi-layer piezo sensor, for converting the mechanical energy into electric energy. The apparatus has a housing onto which the mechanical energy acts in the form of the vibrations, and a vibrating mass provided within the housing. The vibrating mass is clamped with at least two piezo sensor units in the housing. An apparatus thus adapts a piezo sensor energy converter for a wide range of frequencies and amplitudes of mechanical vibrations.

### CROSS REFERENCE TO RELATED APPLICATIONS

This application is based on and hereby claims priority to International Application No. PCT/EP2009/055724 filed on May 12, 2009 and German Application No. 10 2008 029 374.1 filed on Jun. 20, 2008, the contents of which are hereby incorporated by reference.

### BACKGROUND

Piezo multilayer sensors are used as energy converters to generate electrical energy from mechanical energy. If the mechanical energy is present in the form of wide band mechanical vibrations, it is difficult to couple these to the piezo sensor in the optimal manner.

Conventional devices are energy converters, which use mechanical lever transmission with a constant transmission ratio V=constant. The vibration acts from outside on the housing G, shown in FIG. 1. Such a housing G is connected via the lever transmitter V and the energy converter k to a seismic mass m. Because of the inertia of the mass m, the result is a relative movement of this mass m in relation to housing G, with the relative movement acting via the transmitter V on the energy converter k and being converted into electrical energy.

A conventional mechanical transmitter converts the movements and forces as follows:

$$V = \frac{{F}_{Out}}{{F}_{In}} = \frac{{X}_{In}}{{X}_{Out}} \qquad Equation 1$$

with

x_{In} Deflection acting on the mechanical transmitter

x_{Out} Deflection generated by the mechanical transmitter

F_{In} Force acting on the mechanical transmitter

F_{Out} Force generated by the mechanical transmitter. The force amplitude F_{Piezo}, which acts during an external vibration of amplitude x with a frequency f (ω=2πf) of the housing G on the energy converter, is expressed as follows:

$${F}_{Piezo} = V \cdot k \cdot x \cdot ( \frac{1}{1 - \frac{{ω}^{2} \cdot {V}^{2} \cdot m}{k}} - 1 ) \qquad Equation 2$$

with

k Stiffness of the piezo converter

x Amplitude of the vibration stroke

ω Angular frequency of the vibration

m Vibrating mass

F_{Piezo} Resulting force on the piezo converter.

To adapt this apparatus in the optimal way to this vibration x*sin(ωt), the lever transmission Vₘₐₓ must be selected in accordance with the following condition:

$${V}_{max} = \sqrt{\frac{3 \cdot k}{{ω}^{2} \cdot m}} \qquad Equation 3$$

This condition states that, for a given vibrating mass m and given converter stiffness k, the optimal transmission ratio Vₘₐₓ depends on the frequency ω of the vibration. This means that with a changing vibration frequency w the mechanical lever transmission V would also have to be adapted accordingly, in order exert a maximum force on the piezo element and thereby an optimal conversion into electrical energy.

### SUMMARY

One potential object is to provide an apparatus which, for a wide range of frequencies and amplitudes of mechanical vibrations, brings about an effective adaptation to a piezo sensor energy.

The inventors propose methods and devices in which a transmission ratio (V) is variably provided. The transmission ratio is the ratio of the deflection of the vibrating mass to the extension of a piezo actuator by this deflection.

Specifically, the inventors propose that a seismic mass or vibrating mass is clamped between at least two piezo sensor units in a housing frame or housing. In particular the piezo sensor units and the vibrating mass are arranged along a straight line. The vibrating mass is especially positioned in the center between the piezo sensor units allowing it to vibrate.

In accordance with a further advantageous embodiment a piezo sensor unit is a piezo sensor clamped into a spring.

In accordance with a further advantageous embodiment the piezo sensor is a piezo multilayer sensor.

In accordance with a further advantageous embodiment the spring is a tubular spring.

In accordance with a further advantageous embodiment the vibrating mass is able to be deflected at right angles to a longitudinal direction.

In accordance with a further advantageous embodiment a transmission ratio of a deflection of the vibrating mass is inversely proportional in relation to the frame. With this apparatus the transmission ratio of the deflection of the seismic mass is inversely proportional in relation to the frame of the suspension.

In accordance with a further advantageous embodiment an effective stiffness of the vibrating mass spring system is proportional to the square of a deflection. Because of the geometrical circumstances, the lengthening of a spring characterizing the reset forces of the piezo sensor units is proportional to the square of the deflection. The result is that the effective stiffness of the mass spring system is proportional to the square of the deflection. Thus a further advantage emerges in addition to the increased efficiency of the energy conversion of wide band vibrations brought about by the proposals. The stiffness increasing with the vibration amplitude means that the vibrating mass is progressively braked and any possible extreme mechanical shocks are moderated. This means that the position transformation is more robust in relation to extreme mechanical shocks which could damage the piezo materials used.

In accordance with a further advantageous embodiment the springs are essentially subjected to tensile stress. In this way, with a heavy load, the piezo converters clamped under pretension are entirely without pre-tension in the worst case. This is a further reason for the position transformation being more robust in relation to extreme mechanical shocks, which could damage the piezo materials used.

In accordance with a further advantageous embodiment the piezo sensors are pre-tensioned and only subjected to compressive forces. The clamped piezo converters are thus never subjected to tensile stress. Tensile forces can lead to tears and thereby to failure of the piezo converters.

In accordance with a further advantageous embodiment the piezo sensors are fixed in a construction designed for pressure comprising spring sleeves engaging in one another and pre-stressed accordingly. In this way the possibility referred to of the piezo converter with too high a deflection no longer being fixed free from pre-stressing in the tubular spring is circumvented by the construction designed for pressure comprising spring sleeves engaging in one another and pre-stressed accordingly being used for fixing the converter.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 a conventional energy converter;

FIG. 2 an exemplary embodiment of a proposed energy converter;

FIG. 3 a diagram of the deflection behavior of the exemplary embodiment;

FIG. 4 diagrams of the transmission ratio and the effective stiffness of a mass spring system;

FIG. 5 diagrams of frequency spectrums of a conventional energy converter and of an energy converter;

FIG. 6 a further exemplary embodiment of a sleeve construction of a spring designed for pressure.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

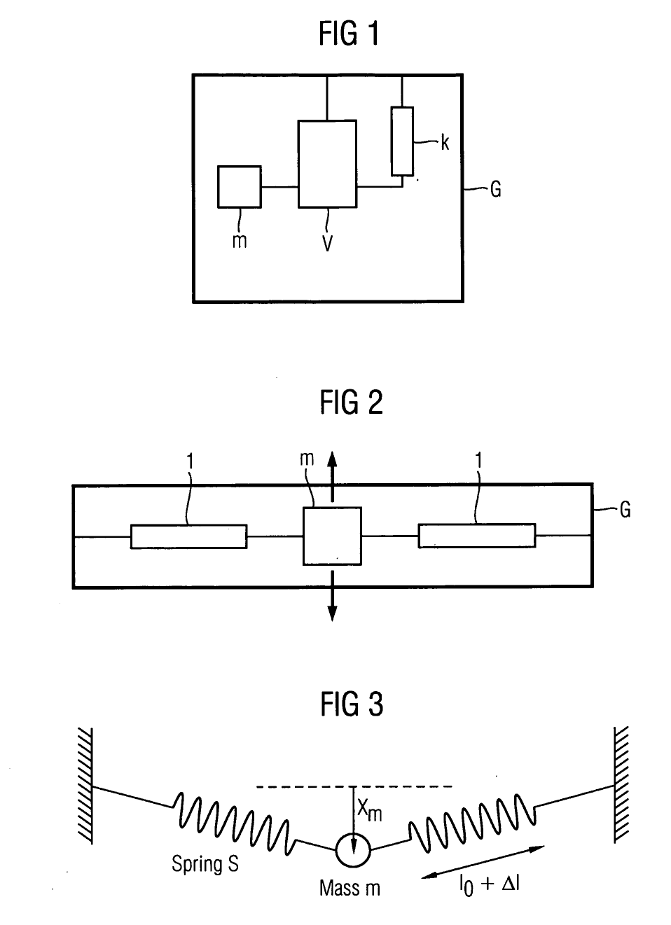

FIG. 1 shows an exemplary embodiment of an energy converter according to the related art. In this embodiment a housing G is provided. Coupled to the housing is a mechanical transmitter with the transmission factor V. Coupled to the mechanical transmitter is a seismic mass m. Also coupled to the mechanical transmitter is a piezo electric converter of stiffness k. The piezo electric converter is likewise coupled directly to the housing G.

FIG. 2 shows an exemplary embodiment of the proposed energy converter. In this figure reference sign 1 designates a piezo sensor unit. A seismic mass m is fixed via at least 2 piezo sensor units 1 in a frame of a housing G. A piezo sensor unit 1 is a piezo multilayer sensor unit clamped into a tubular spring. In this case a piezo sensor unit 1 is coupled to a housing G and to the seismic mass m. As a result of the geometrical circumstances, the force and movement directions are shown by arrows, the lengthening Δl characterizing the reset forces of the piezo sensor units 1 is proportional to the square of the deflection xₘ. The result is that the effective stiffness of the mass spring system is proportional to the square of the deflection.

FIG. 3 shows a diagram for the deflection behavior of the mass spring system of the exemplary embodiment. In this diagram the letter S designates a spring. Two springs hold a mass m between a housing G. The springs can be fixed to a frame of the housing G. The mass m is able to be defected at right angles to a longitudinal direction of the springs. With a deflection xₘ the original length l₀ is expanded by a length Δl.

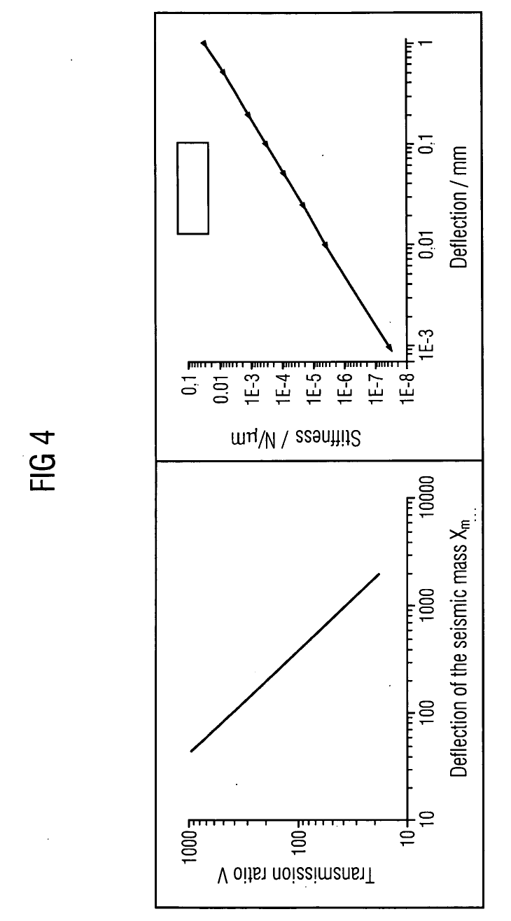

FIG. 4 shows diagrams relating to the transmission ratio and the effective stiffness of the mass spring system in accordance with the proposals. FIG. 4 shows on the left-hand side the transmission ratio V over the deflection of the seismic mass xₘ FIG. 4 shows on the right-hand side the effective stiffness of the mass spring system over the deflection of the seismic mass xₘ. The variable transmission ratio V=f(xₘ)=a/xₘ brings about an improved force effect on the piezo converter compared to a fixed transmission ratio V=constant. In the overall frequency range considered calculations prove an increased force amplitude at the energy converters.

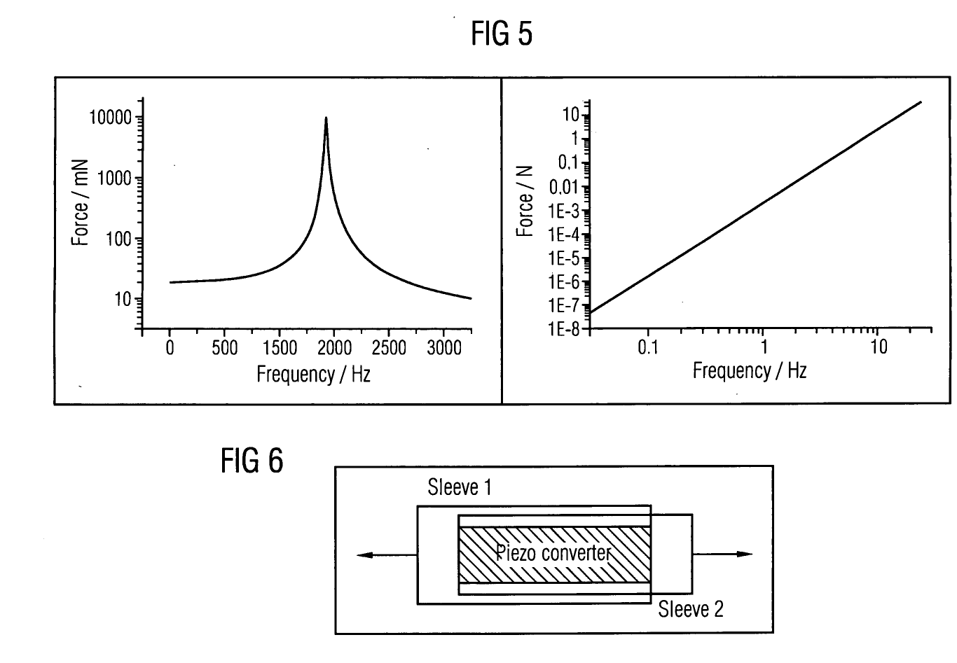

FIG. 5 shows graphs for the frequency spectrum of the force amplitudes created at the converters. In this figure the left-hand diagram shows a conventional constant transmission ratio V=constant. The right-hand diagram shows a variable transmission ratio V=f(xₘ)=a/xₘ. In these diagrams the force is plotted against the frequency in each case.

FIG. 6 shows a further exemplary embodiment of a proposed piezo sensor unit 1. This circumvents the possibility of a piezo converter no longer being fixed in the tubular spring without pre-stressing if the deflection is too great. A construction designed for pressure comprising spring sleeves engaging within one another and pre-stressed accordingly is used in this case for fixing the piezo converter. FIG. 6 shows a sleeve construction designed for pressure.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. An apparatus for coupling mechanical energy in the form of wide band mechanical vibrations into electrical energy, comprising:
a housing, on which the mechanical energy acts in the form of vibrations;
a vibrating mass vibrated by the mechanical vibrations; and
a piezo sensor for converting mechanical energy from the vibrating mass into electrical energy, wherein
the vibrating mass is coupled to the housing via the piezo sensor such that deflection of the vibrating mass causes compression/extension of the piezo sensor, and
the vibrating mass is coupled to the housing via the piezo sensor with a transmission ratio that varies with vibration frequency of the vibrating mass, the transmission ratio being a ratio of deflection of the vibrating mass to compression/extension of the piezo sensor.

15. The apparatus as claimed in claim 14, wherein
the vibrating mass is clamped in the housing between at least two piezo sensor units.

16. The apparatus as claimed in claim 15, wherein
the apparatus has at least two piezo sensors such that each piezo sensor unit includes at least one piezo sensor clamped to a spring.

17. The apparatus as claimed in claim 16, wherein
each piezo sensor is a piezo multilayer sensor.

18. The apparatus as claimed in claim 16, wherein
each spring is a tubular spring.

19. The apparatus as claimed in claim 16, wherein
the vibrating mass vibrates in a direction perpendicular to a longitudinal direction of the springs.

20. The apparatus as claimed in claim 14, wherein
the transmission ratio is inversely proportional to deflection of the vibrating mass in relation to the housing.

21. The apparatus as claimed in claim 14, wherein
springs are used to couple the vibrating mass to the housing and form a vibrating mass/spring system, and
an effective stiffness of the vibrating mass/spring system is proportional to a square of a deflection of the vibrating mass in relation to the housing.

22. The apparatus as claimed in claim 14, wherein
springs are used to couple the vibrating mass to the housing, and
the springs are stressed for tension.

23. The apparatus as claimed in claim 14, wherein
the piezo sensor is pre-stressed, and
deflection of the vibrating mass subjects the piezo sensor to compression forces.

24. The apparatus as claimed in claim 23, further comprising:
a pair of engaging sleeves, the piezo sensor being fixed to at least one of the sleeves;
a biased connector to connect the pair of engaging sleeves and bias the pair of engaging sleeves toward one another; and
at least one spring to connect the pair of engaging sleeves to the housing, the at least one spring maintaining the piezo sensor in a pre-tensioned condition such that vibrations of the vibrating mass subject the sensor to compression forces.

25. A method for converting mechanical energy into electrical energy, comprising:
using the mechanical energy to vibrate a mass with a frequency spectrum from zero to 100 Hz and with force amplitudes in the range of 10⁻⁸ to 100 100 N;
using a piezo sensor to convert mechanical energy from the vibrating mass into electrical energy; and
connecting the vibrating mass to a housing via a piezo sensor such that deflection of the vibrating mass causes compression/extension of the piezo sensor, the vibrating mass being coupled to the housing via the piezo sensor with a transmission ratio that varies with vibration frequency of the vibrating mass, the transmission ratio being a ratio of deflection of the vibrating mass to compression/extension of the piezo sensor.

26. The method as claimed in claim 25, wherein
the vibrating mass moves in a deflection range from 10⁻³ to 1 mm, and
the vibrating mass is connected to the housing with a spring connection, the spring connection having an effective stiffness ranging from 10⁻⁸ to 0.1 N/μm at 1 kg vibrating mass.
